(19) United States
(12) Patent Application Publication
(10) Pub. No.: US 2007/0098482 A1
(43) Pub. Date: May 3, 2007

(54) Paint applying device

(76) Inventor: Miguel Wang, Hsiu-Shui Hsiang (TW)

Correspondence Address: SEYFARTH SHAW LLP, 131 S. DEARBORN ST., SUITE2400, CHICAGO, IL, 60603-5803, US

(21) Appl. No.: 11/336,353

(22) Filed: Jan. 20, 2006

Related U.S. Application Data
(63) Continuation-in-part of application No. 11/264,252, filed on Nov. 1, 2005.

(51) Int. Cl. B43K 5/00; B43M 11/06

(52) U.S. Cl. 401/205; 401/207; 401/183

(57) ABSTRACT

A paint applying device includes a hollow handle, a connector, a holder, and a hollow absorbent member. The hollow handle defines a paint storing space. The connector is connected fluidly and removably to the hollow handle. The holder includes a rear inlet portion connected fluidly and removably to the connector, a front outlet end opposite to the rear inlet portion, and a paint passage extending between the rear inlet portion and the front outlet end. The hollow absorbent member is sleeved around the holder, and includes a rear open end portion extending around the holder, and a front closed end portion extending forwardly of the front outlet end of the holder. The front closed end portion of the hollow absorbent member is connected fluidly to the front outlet end of the holder.

### CROSS-REFERENCE TO RELATED APPLICATION

This application is a continuation-in-part of co-pending U.S. patent application Ser. No. 11/264,252, filed on Nov. 1, 2005.

### BACKGROUND OF THE INVENTION

1. Field of the Invention

The invention relates to a paint applying device, more particularly to a paint applying device which can supply paint continuously.

2. Description of the Related Art

A paint roller and a paint brush are two types of paint applicators. Conventionally, the paint roller requires repeated dipping of a roller portion of the paint roller into a tray of paint when conducting the painting activity. Similarly, the paint brush requires repeated dipping of bristles of the paint brush into a container of paint. Therefore, the conventional paint roller and paint brush are relatively inconvenient to use. Furthermore, cleaning of the conventional paint applicators, especially the paint brush, is often a time consuming and tedious activity. Normally, the bristles of the paint brush are cleaned by washing the bristles in a bucket of cleaning fluid or water. However, it is difficult to clean the bristles of the paint brush to the satisfaction of the user of the paint brush. Additionally, only the outer bristles have direct contact with the cleaning fluid or water in the bucket. Therefore, the cleaning fluid or water in the bucket cannot effectively penetrate or circulate throughout the bristles such that the bristles are not thoroughly cleaned.

Referring to FIGS. 1 and 2, a paint brush disclosed in Taiwanese Patent Publication No. 543395 includes a handle 10, a body member 20, bristles 30, and a plug member 40.

The handle 10 includes a paint inlet end portion 11, a paint outlet end portion 12 opposite to the paint inlet end portion 11, and a paint passage 13 fluidly communicating with the paint inlet end portion 11 and the paint outlet end portion 12.

The body member 20 is connected to the paint outlet end portion 12 of the handle 10, and includes an inlet portion 21 connected fluidly to the paint passage 13 of the handle 10, and an assembling portion 22 for assembling the bristles 30 and the plug member 40 therein.

The plug member 40 includes an annular bristle-assembling portion 41, and a plurality of paint outlet holes 42. During assembly, the bristles 30 are first assembled in the annular bristle-assembling portion 41 of the plug member 40, and the plug member 40 with the bristles 30 are then assembled in the assembling portion 22 of the body member 20.

When the paint brush is in use, paint can flow from the paint inlet end portion 11 of the handle 10 to the bristles 30 via the paint passage 13 of the handle 10, the paint outlet end portion 12, the inlet portion 21 of the body member 20, and the paint outlet holes 42 of the plug member 40 so that the bristles 30 can be supplied with the paint continuously.

However, the aforesaid paint brush has the following disadvantages:

1. After a period of use, the paint outlet holes 42 of the plug member 40 are likely to be blocked due to solidification of the paint. Therefore, the bristles 30 can not be provided with the paint efficiently.

2. In the aforesaid paint brush, the bristles 30 are coated entirely with the paint. However, it is only required to provide the distal portions of the bristles 30 with the paint when conducting the painting activity. Therefore, the aforesaid paint brush suffers from a problem of unnecessary consumption of the paint. Furthermore, it is relatively difficult to clean the paint brush to the satisfaction of the user.

3. The bristles 30 of the aforesaid paint brush can not be replaced with new ones after a period of use.

### SUMMARY OF THE INVENTION

Therefore, the object of the present invention is to provide a paint applying device which can supply paint continuously, and which can avoid ineffective consumption of the paint.

In the first aspect of this invention, a paint applicator unit includes a holder and a hollow absorbent member. The holder includes a rear inlet portion, a front outlet end opposite to the rear inlet portion, and a paint passage extending between the rear inlet portion and the front outlet end. The hollow absorbent member is sleeved around the holder, and includes a rear open end portion extending around the holder, and a front closed end portion extending forwardly of the front outlet end of the holder. The front closed end portion of the hollow absorbent member is connected fluidly to the front outlet end of the holder.

In the second aspect of this invention, a paint applying device includes a hollow handle, a connector, a holder, and a hollow absorbent member. The hollow handle defines a paint storing space. The connector is connected fluidly and removably to the hollow handle. The holder includes a rear inlet portion connected fluidly and removably to the connector, a front outlet end opposite to the rear inlet portion, and a paint passage extending between the rear inlet portion and the front outlet end. The hollow absorbent member is sleeved around the holder, and includes a rear open end portion extending around the holder, and a front closed end portion extending forwardly of the front outlet end of the holder. The front closed end portion of the hollow absorbent members connected fluidly to the front outlet end of the holder.

### BRIEF DESCRIPTION OF THE DRAWINGS

Other features and advantages of the present invention will become apparent in the following detailed description of the preferred embodiment with reference to the accompanying drawings, of which:

FIG. 1 is a sectional view of a conventional paint brush;

FIG. 2 is another sectional view of the conventional paint brush;

FIG. 3 is an exploded perspective view of a preferred embodiment of a paint applying device according to this invention;

FIG. 4 is a sectional view of the preferred embodiment;

FIG. 5 is a schematic view of the preferred embodiment; and

FIGS. 6 and 7 are sectional views showing consecutive steps of assembling the preferred embodiment.

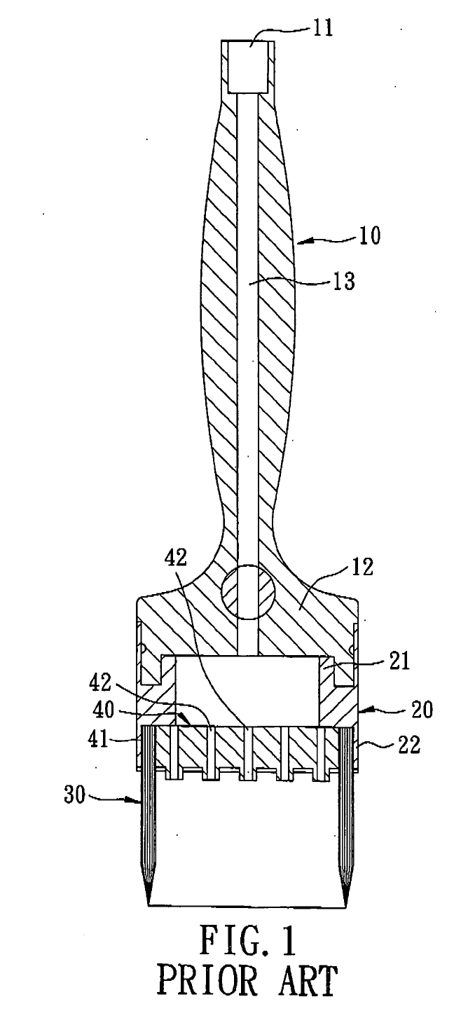

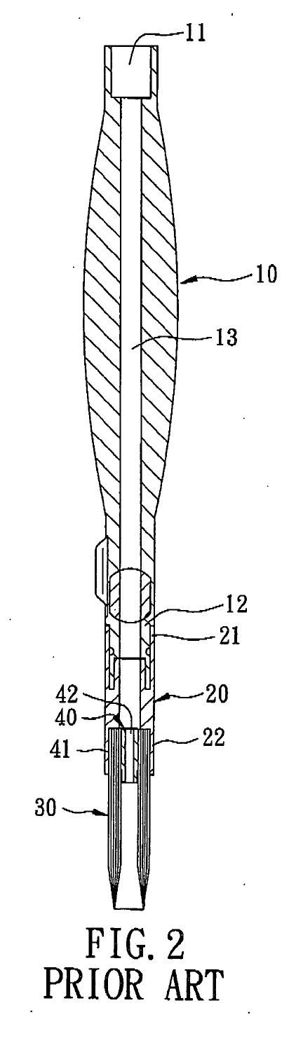

### DETAILED DESCRIPTION OF THE PREFERRED EMBODIMENT

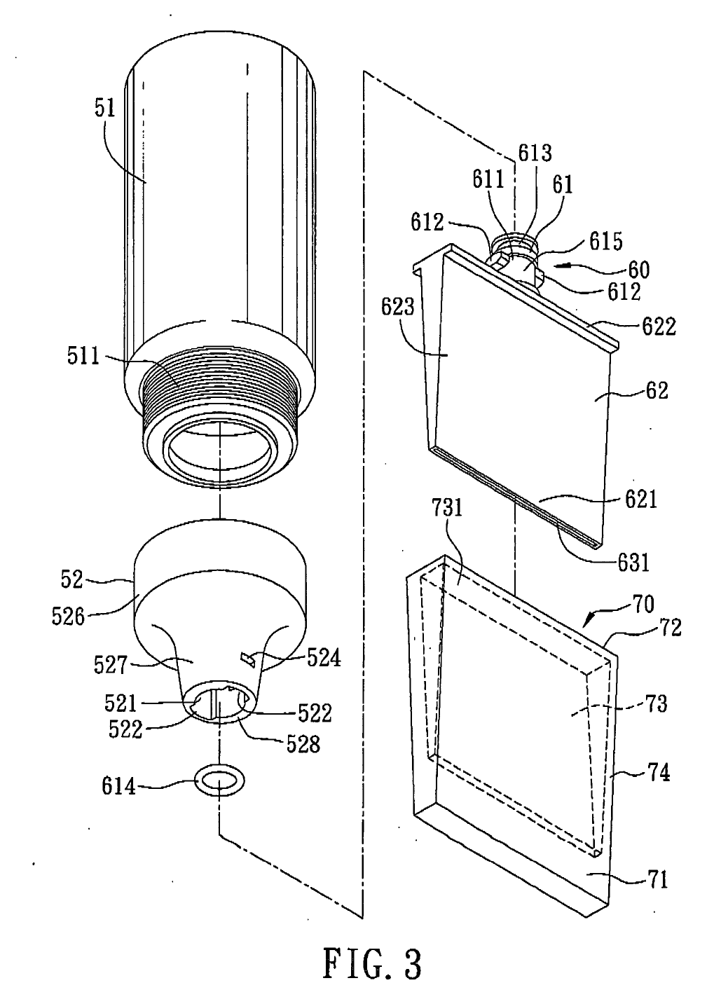

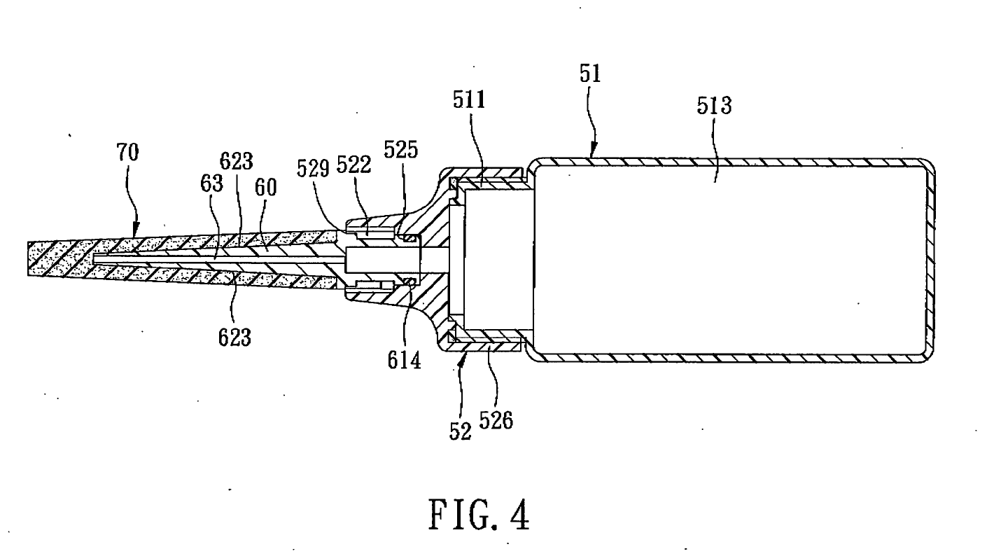

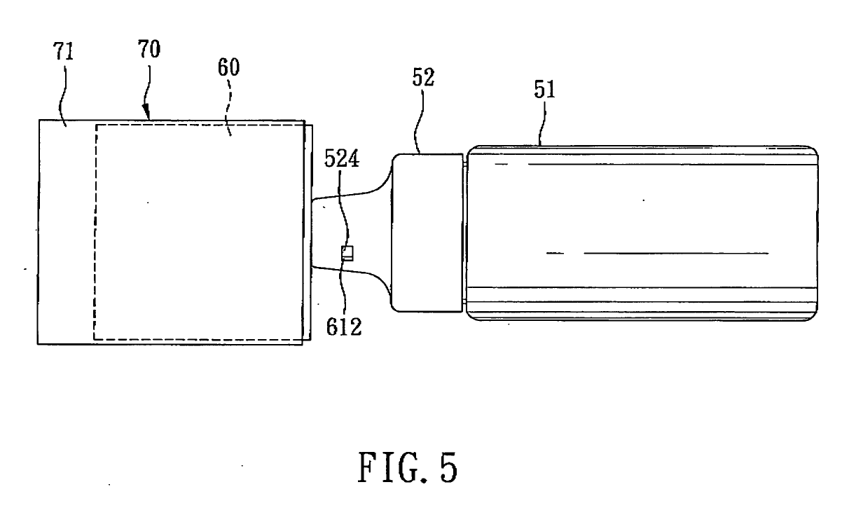

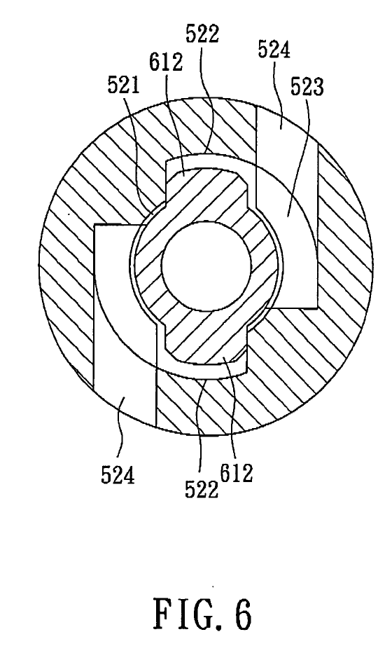

Referring to FIGS. 3, 4, 5, and 6, the preferred embodiment of a paint applying device according to this invention is shown to include a hollow handle 51, a connector 52, a holder 60, and a hollow absorbent member 70. The holder 60 and the hollow absorbent member 70 constitute a paint applicator unit.

The hollow handle 51 is configured as an elongate compressible container so as to define a paint storing space 513, and includes a first threaded hollow connecting portion 511.

The connector 52 is connected fluidly and removably to the hollow handle 51. Specifically, the connector 52 includes a second threaded hollow connecting portion 526 connected threadedly to the first threaded hollow connecting portion 511 of the hollow handle 51, and a spout 527 having a cross-section smaller than that of the second threaded hollow connecting portion 526. The spout 527 includes a tubular wall 528 defining an axial fastening hole 521 with an open end 529, two limiting recesses 522 formed in an inner surface of the tubular wall 528 and extending radially from the axial fastening hole 521 and axially toward the open end 529 of the fastening hole 521, two through holes 524 extending through the tubular wall 528 and staggered angularly with the limiting recesses 522, respectively, and limiting grooves 523, each of which extends angularly from a corresponding one of the limiting recess 522 to a corresponding one of the through holes 524. The tubular wall 528 of the spout 527 of the connector 52 further has an annular sealing groove 525, the radius of which is smaller than that of each of the limiting grooves 523.

The holder 60 includes a rear inlet portion 61 connected fluidly and removably to the spout 527 of the connector 52, a front outlet end 621 opposite to the rear inlet portion 61 and formed with an elongate opening 631, a substantially wedge-shaped hollow plate body 62 that tapers to the front outlet end 621 from the rear inlet portion 61, and a paint passage 63 formed in the hollow plate body 62 and extending between the rear inlet portion 61 and the front outlet end 621.

The hollow absorbent member 70 is sleeved around the holder 60, and includes a rear open end portion 72 extending around the holder 60, and a front closed end portion 71 extending forwardly of the front outlet end 621 of the holder 60. The front closed end portion 71 of the hollow absorbent member 70 is connected fluidly to the front outlet end 621 of the holder 60.

The hollow absorbent member 70 further includes a foam body 74 that extends from the rear open end portion 72 to the front closed end portion 71, and that has a cavity 73 receiving the wedge-shaped hollow plate body 62 and having an opening 731 in the rear open end portion 72. The wedge-shaped hollow plate body 62 further has two opposite outer faces 623, and a flanged end portion 622 projecting from the outer faces 623 adjacent to the opening 731 of the cavity 73 to abut against the rear open end portion 72 of the hollow absorbent member 70.

The rear inlet portion 61 of the holder 60 further includes a hollow neck 611 projecting rearward from the flanged end portion 622 of the wedge-shaped hollow plate body 62 and connected removably to the spout 527 of the connector 52. The hollow neck 611 has an annular wall 615 inserted into the fastening hole 521 of the tubular wall 528 of the spout 52, two limiting blocks 612 protruding outwardly from the annular wall 615 at two diametrically opposite positions, an annular sealing recess 613 formed on an outer surface of the annular wall 615 proximate to the limiting blocks 612, and a sealing ring 614 disposed in the annular sealing recess 613. The annular sealing groove 525 of the tubular wall 528 of the spout 527 engages the sealing ring 614.

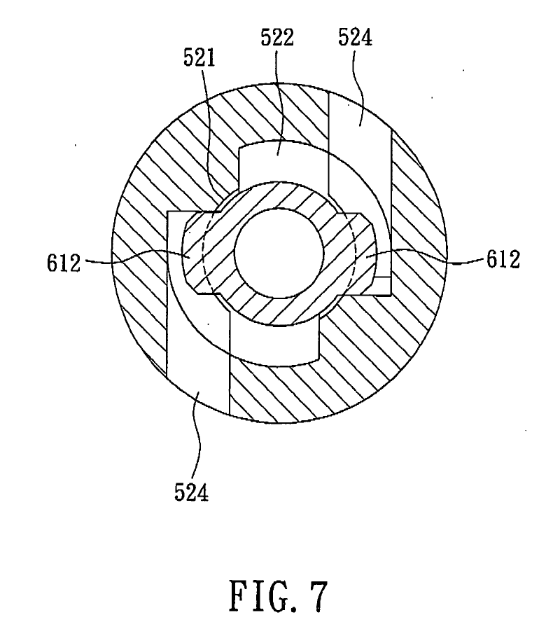

Referring to FIG. 7, the limiting blocks 612 are engaged in the through holes 524, respectively, after passing through the limiting recesses 522 and the limiting grooves 523 upon rotation of the holder 60 relative to the connector 52.

In use, when the hollow handle 51 is filled with paint therein and is then compressed, the paint flows continuously from the hollow handle 51 to the front outlet end 621 of the holder 60 via the spout 52 and the rear inlet portion 61 and the paint passage 63 of the holder 60. The front closed end portion 71 of the hollow absorbent member 70 absorbs the paint passing through the elongate opening 631 of the holder 60 so that paint application can be conducted. Therefore, it is not necessary to soak the whole hollow absorbent member 70 with the paint. The problem of ineffective consumption of the paint suffered in the prior art can be avoided accordingly.

Furthermore, the foam body 74 of the hollow absorbent member 70 is used to conduct the paint application, and the elongate opening 631 is relatively large as compared to the paint outlet holes 42 of the plug member 40 of the aforesaid prior art. Therefore, cleaning of the paint applying device of the present invention can be conducted with relative ease.

It should be noted that since paint application can be conducted using the front closed end portion 71 of the hollow absorbent member 70, the remaining portion of the hollow absorbent member 70, i.e., except the front closed end portion 71, can be made of a material other than foam material.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A paint applicator unit, comprising:
a holder including a rear inlet portion, a front outlet end opposite to said rear inlet portion, and a paint passage extending between said rear inlet portion and said front outlet end; and
a hollow absorbent member sleeved around said holder, and including a rear open end portion extending around said holder, and a front closed end portion extending forwardly of said front outlet end of said holder, said front closed end portion of said hollow absorbent member being connected fluidly to said front outlet end of said holder.

2. The paint applicator unit as claimed in claim 1, wherein said holder includes a substantially wedge-shaped hollow plate body that tapers to said front outlet end from said rear inlet portion.

3. The paint applicator unit as claimed in claim 2, wherein said hollow absorbent member includes a foam body that extends from said rear open end portion to said front closed end portion, and that has a cavity receiving said wedge-shaped hollow plate body and having an opening in said rear open end portion.

4. The paint applicator unit as claimed in claim 3, wherein said wedge-shaped hollow plate body further has two opposite outer faces, and a flanged end portion projecting from said outer faces adjacent to said opening of said cavity to abut against said rear open end portion of said hollow absorbent member.

5. The paint applicator unit as claimed in claim 4, wherein said rear inlet portion of said holder further includes a hollow neck projecting rearward from said flanged end portion.

6. The paint applicator unit as claimed in claim 5, wherein said hollow neck has an annular wall, two limiting blocks protruding outwardly from said annular wall at two diametrically opposite positions, and an annular sealing recess formed on an outer surface of said annular wall proximate to said limiting blocks.

7. A paint applying device, comprising:
a hollow handle defining a paint storing space;
a connector connected fluidly and removably to said hollow handle;
a holder including a rear inlet portion connected fluidly and removably to said connector, a front outlet end opposite to said rear inlet portion, and a paint passage extending between said rear inlet portion and said front outlet end; and
a hollow absorbent member sleeved around said holder, and including a rear open end portion extending around said holder, and a front closed end portion extending forwardly of said front outlet end of said holder, said front closed end portion of said hollow absorbent member being connected fluidly to said front outlet end of said holder.

8. The paint applying device as claimed in claim 7, wherein said hollow handle is compressible.

9. The paint applying device as claimed in claim 7, wherein said hollow handle includes a first threaded hollow connecting portion, said connector including a second threaded hollow connecting portion connected threadedly to said first threaded hollow connecting portion, and a spout connected to said rear inlet portion of said holder and having a cross-section smaller than that of said second threaded hollow connecting portion.

10. The paint applying device as claimed in claim 7, wherein said holder includes a substantially wedge-shaped hollow plate body which tapers to said front outlet end from said rear inlet portion, said rear inlet portion of said holder including a hollow neck projecting from said wedge-shaped hollow plate body and connected to said spout.

11. The paint applying device as claimed in claim 10, wherein said spout includes a tubular wall defining an axial fastening hole with an open end, a limiting recess formed in an inner surface of said tubular wall and extending radially from said axial fastening hole and axially toward said open end of said fastening hole, a through hole extending through said tubular wall and staggered angularly with said limiting recess, and a limiting groove extending angularly from said limiting recess to said through hole, said hollow neck including an annular wall inserted into said fastening hole of said tubular wall, and a limiting block protruding from said annular wall, said limiting block being engaged in said through hole after passing through said limiting recess and said limiting groove upon rotation of said holder relative to said connector.

12. The paint applying device as claimed in claim 11, wherein said hollow neck further includes an annular sealing recess proximate to said limiting block, and a sealing ring disposed in said annular sealing recess, said tubular wall of said spout of said connector having an annular sealing groove to engage said sealing ring.

13. The paint applying device as claimed in claim 10, wherein said hollow absorbent member includes a foam body that extends from said rear open end portion to said front closed end portion, and that has a cavity receiving said wedge-shaped hollow plate body and having an opening in said rear open end portion.
